(19) United States
(12) Patent Application Publication
(10) Pub. No.: US 2008/0115062 A1
(43) Pub. Date: May 15, 2008

(54) Video user interface

(75) Inventors: William Ngan, Redmond, WA (US); Malek Chalabi, Redmond, WA (US); Eric Lang, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/600,682

(22) Filed: Nov. 15, 2006

(51) Int. Cl. G11B 27/00

(52) U.S. Cl. 715/723

(57) ABSTRACT

A video user interface allows video content to be manipulated to accommodate user-interface (UI) navigation and to enable UI customization. The video-user interface incorporates video contents into a user interface, manipulates selected video contents to accommodate UI navigation, and makes the video contents interchangeable so as to enable UI customization. Special effects can be applied to transitions between keyframes associated with selected video content.

### BACKGROUND

Computers use graphics, animation, sounds, and the like to provide information to a user. Conventional utilities for providing such information often require learning a complex computer language and hard-coding programs for a target system for presenting the information to users. Similar problems exist when a target system is programmed to receive various responses from the users. Synchronization of multiple resources is also difficult when attempting to synchronize utilities for sound, graphics, and animation using the conventional utilities.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

The present disclosure is directed to a user interface for incorporating video contents such that the video contents can be manipulated to accommodate user-interface (UI) navigation. The video contents can be made to operate with a navigation structure so that UI customization can be enabled by using the same (or similar) navigation structure with different video content. For example, video contents (which can comprise static or animated media) can be easily combined with functionality by a service provider to create a customized video menu. Providing customizable menus enable the service providers (who might otherwise not be programmers) to provide a compelling experience for the users of the customized menus.

Two major challenges in UI design are to create a “rich and beautiful” user experience, and making the UI customizable by service providers (such as kiosk vendors) that are targeted for different users in various contexts. A video user interface is disclosed that incorporates video contents into a user interface, manipulates selected video contents to accommodate UI navigation, and makes the video contents interchangeable so as to enable UI customization.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

FIG. 1 is an illustration of an example operating environment and system for video user interfaces.

FIG. 2 is an illustration of a high-level diagram of a video user interface structure.

FIG. 3 is an illustration of an operation of a selected menu item.

FIG. 4 is an illustration of a collection of non-linear video playing in a video user interface.

FIG. 5 is an illustration of single- and multi-layer composition of text and video in a video user interface.

FIG. 6 is an illustration of different videos that have a similar underlying menu structure.

FIG. 7 is a flow graph illustrating a video user interface.

### DETAILED DESCRIPTION

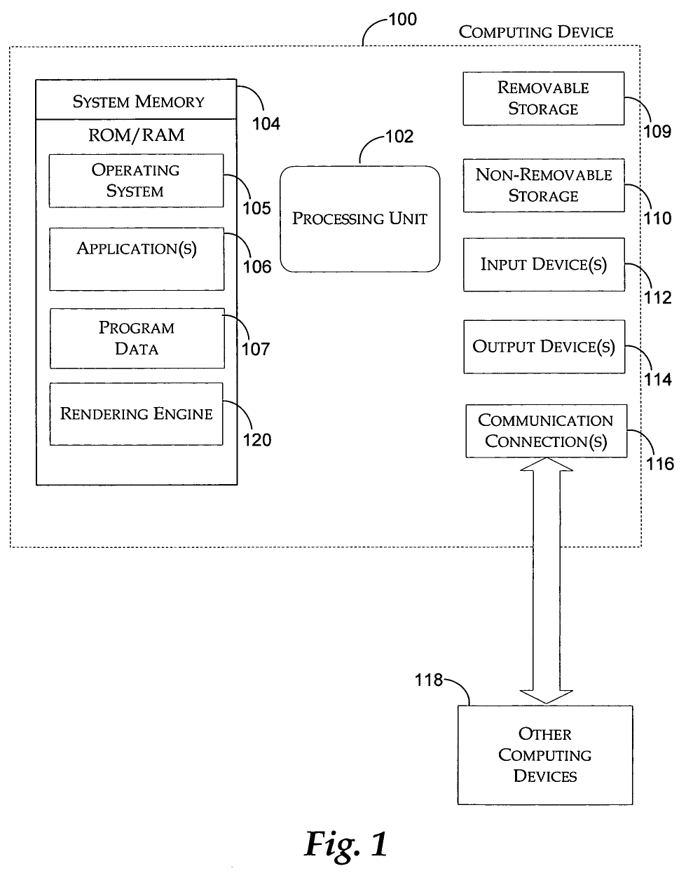

As briefly described above, embodiments are directed to dynamic computation of identity-based attributes. With reference to FIG. 1, one example system for video user interfaces includes a computing device, such as computing device 100. Computing device 100 may be configured as a client, a server, a mobile device, or any other computing device that interacts with data in a network based collaboration system. In a basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107 in which rendering engine 120, can be implemented in conjunction with processing 102, for example.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

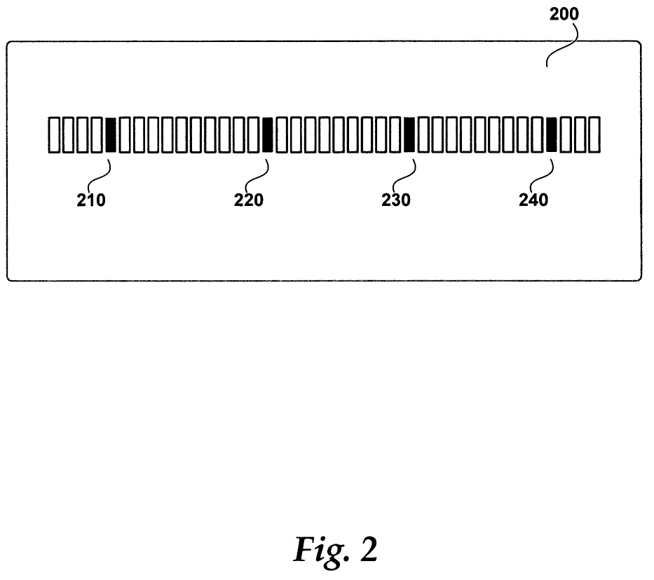

In accordance with the discussion above, computing device 100, system memory 104, processor 102, and related peripherals can be used with video user interface 120. Video user interface 120 in an embodiment can be used to allow service providers to create customized video user interfaces (described below with reference to FIGS. 2-6).

FIG. 2 is an illustration of a high-level diagram of a video user interface structure. The Figure illustrates a frame structure 200. Frame structure 200 comprises frames, such as keyframes 210, 220, 230, and 240, discussed below. A video can be a collection of frames, and the video user interface can comprise a collection of videos. Each video has a defined structure that can be specified by specific frames (e.g., “keyframes”) that correspond to selectable items in the user interface.

A keyframe can be used to establish a link between time-based media and an abstract collection of items to be used to provide functionality to the menu. Keyframes can be distributed at predetermined locations (“predefined structure”) and/or by marking selected frames (“tagging”). Keyframes may or may not be uniformly distributed across the video. Thus keyframes 210, 220, 230, and 240 in accordance with a predefined frame structure can be predefined to be at frame #5, #21, #31 and #41, respectively, and/or each frame can be marked individually by tags according to video contents. The video user interface can apply to any standard or special video codec (for JPG sequences, MPG sequences, WMV sequences, WAV files, MIDI files, and the like) with or without metadata embedded.

In operation, a service provider uses the video user interface to select media resources and provide functionality to be selected by a user. The user offered the menu, via a kiosk, for example, can select menu items to cause actions to be performed, such as purchases, downloading, and navigation through the menu structure.

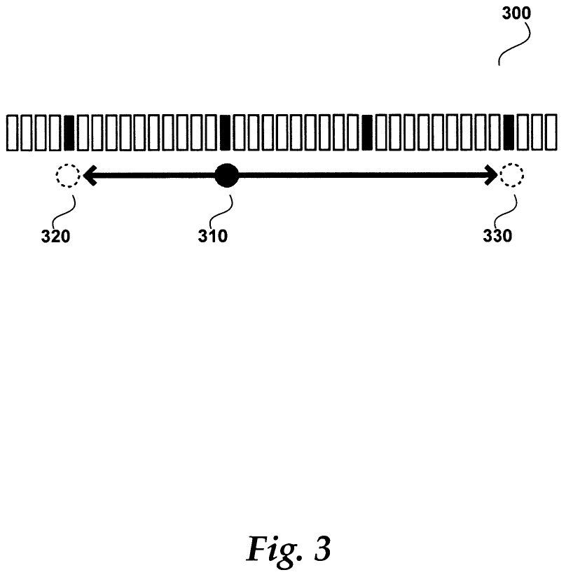

FIG. 3 is an illustration of an operation of a selected menu item. Navigation structure 300 contains commands associated with particular keyframes. Indicator 310 is shown as corresponding to a keyframe that is the most recently selected item. Indicators 320 and 330 indicate potential target frames that can be navigated to by selecting menu items for navigation.

When the user scrolls through selectable items in a video user interface menu, the video content is played backward or forward to the targeted keyframe, which then corresponds to the most recently selected item. As a result, smooth animated transitions (from a previously selected keyframe to a most recently selected keyframe) occur when the selection changes. Using a control (such as by selecting a menu item), the video can be, for example, played forward or backwards, at variable speed (or speeds) to a targeted menu-item frame.

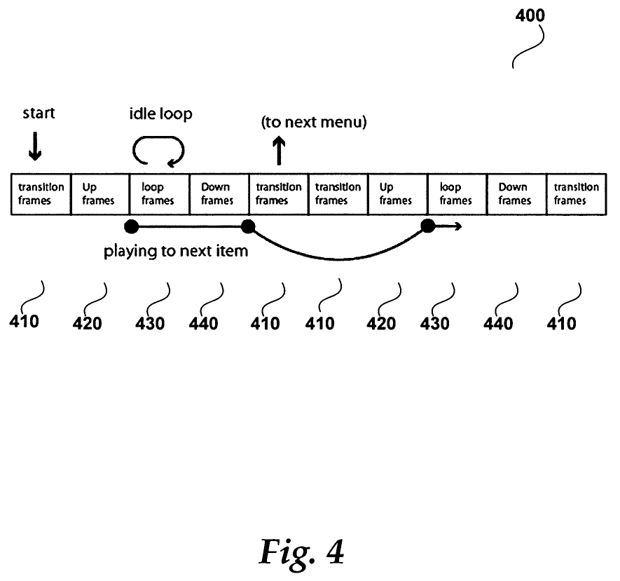

FIG. 4 is an illustration of a collection of non-linear video playing in a video user interface. The video does not need to be played linearly. For example, there can be small segments within the video that are looped when a user is not actively controlling the user interface. Likewise, other segments can be reserved for transition effects between screens, screen saver, and other functions. Additionally, audio can be added as a part of the navigable frame sequence, synchronized with keyframes, and/or triggered and played on encountered events.

Frame collection 400 comprises frames demarcated at keyframe boundaries (“video segments”). For example, segment 410 can be used to provide a “splash screen” introduction to the menu when the menu is first activated. Segments 420 can be used when navigating “up” as in a tree of menu selection items. Segments 430 can be used as loop segments (which allow the menu display to increase user interest through animated effects, for example). Segments 440 are down frames that can be used when navigating “down” as in a tree of menu selection items. As discussed above, audio can be sequenced in conjunction with the user's navigation of the menu.

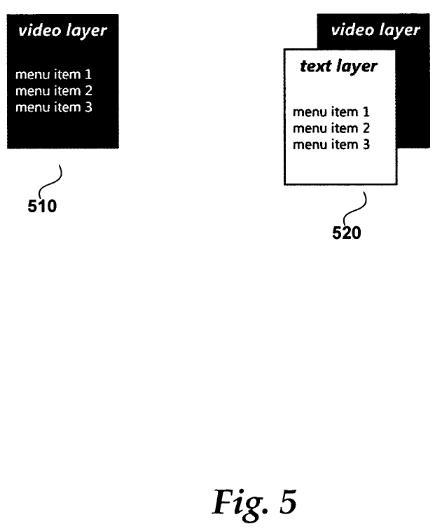

FIG. 5 is an illustration of single- and multi-layer composition of text and video in a video user interface. Each video user interface screen can comprise a single video, or comprise a composition of video and other user interface elements. For example, user interface screen 510 comprises text labels and other graphics that can be embedded as part of the video (single layer composition), whereas user interface screen 520 comprises separate layers that are superimposed over the video layer (multi-layer composition).

Because of the flexibility offered by video, video user interface menu layouts are not to be constrained to conventional vertical-list formats. In contrast, service providers can use the video user interface menu layouts to provide a broad range of creative treatments such as three-dimension layouts and/or special effects like water ripples or fog and smoke. Additionally, a render engine for the user interface can be used to provide the special dynamic capabilities on texts, shapes, and static user interface elements, manipulating and synchronizing them to the underlying video user interface. The dynamic capabilities comprise functions such as scale, move, rotate, fade, color, and the like.

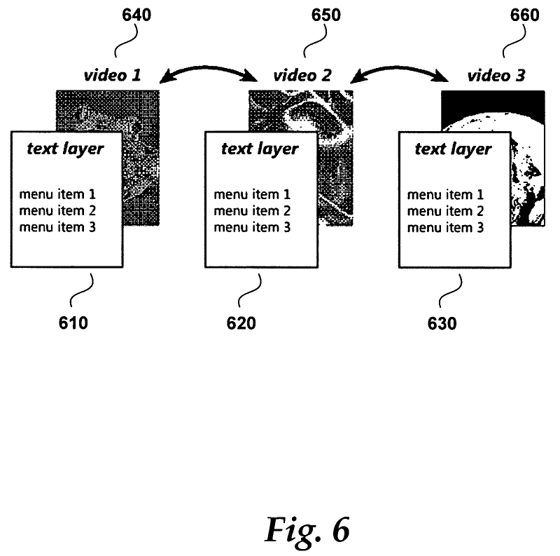

FIG. 6 is an illustration of different videos that have a similar underlying menu structure. User interface customization can be achieved by simply replacing one video with another video because the same underlying structure can be linked (or otherwise associated with) different videos.

For example, text layers 610, 620, 630 can be identical or slightly modified to be substantially similar from the programmer's point of view. Text layer 610 can be associated with video 640, which is different from video 650. Text layer 620 can be associated with video 650, which is different from video 660. Text layer 630 can be associated with video 660. Thus the effort used to make menu structures (such as text layers) can be used and reused efficiently to make a variety of menus that appear to be different, but yet retain a user interface that is learned and becomes familiar to groups of targeted users.

Linking a common (or similar) underlying structure to different videos facilitates the process of making customized video user interfaces. One example is personalizing menu content such as making video user interfaces for specific people. Another example is generating dynamic content in response to various contexts and locations such as loading a new UI through a wireless network. Additionally, promotional and advertisement-based user interfaces can be quickly ported to time-sensitive product such as a new movie or music video. Further, menu items can be linked to a time clock to provide, for example, morning, noon, afternoon, and evening product offerings.

Various applications for the video user interface may include a platform for advertisement-based contents (such as movies, downloadable audio content, soft-drink products, and/or other time-sensitive product sales. The video user interface also enables selling and sharing video user interface clips, through linking websites and/or wireless services. Custom branded video user interfaces can be easily created and updated by, for example, custom branding menus on corporate mobile phones to provide corporate branding and standardized functionality to employees. The video user interface also provides another medium through which artists and designers can create artistic and expressive interfaces and personalized narratives of arbitrary media content.

Tools can be provided to facilitate service providers in creative (as well as functional) processes of making video user interfaces. The reuse of components in a tool context can allow relative novices to create professional quality presentations.

The tools for making the video user interfaces can be organized as stand-alone tools, plug-ins, or incorporated into hardware products. For example stand-alone tools can be used to make user-navigable video and audio clips. The commands of the stand-alone tools can be configured specifically for making video user interfaces, which allows the user interface to be constrained, and thus easier for users to learn and use.

Plug-ins can be provided for standard video/audio editing tools to incorporate video user interface creation and playback functionality in the existing tools. The users, who are familiar with the transport and editing controls of the existing tools, can readily assimilate the controls of the plug-in (which can be constrained to video user interface functionality).

The video user interface functionality can be incorporated into hardware products. For example, a video camera can be equipped with special with special editing software on the device that can be used to create customized navigable videos. Additionally an electronic kiosk can also include the video user interface software, such that a service provider (who presumably knows the needs of the consumer) can generate a customized video user interface at the point-of-sale.

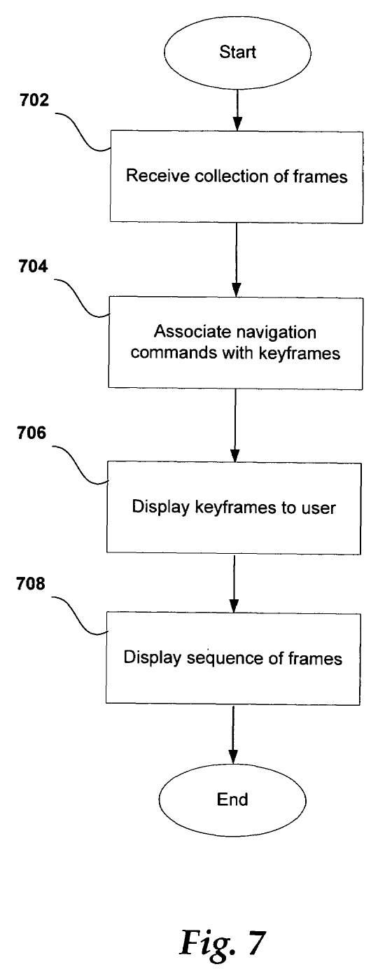

FIG. 7 is a flow graph illustrating a video user interface. In operation 702, a collection of frames that comprise keyframes is received. In operation 704, navigation commands are associated with the keyframes. In operation 706, menu items in keyframes are displayed to a user. In operation 708, a sequence of frames is displayed in response to a command from a user received in response to a selection of at least one of the menu items in a displayed keyframe.

The above specification, examples and data provide a complete description of the manufacture and use of embodiments of the invention. Since many embodiments of the invention can be made without departing from the spirit and scope of the invention, the invention resides in the claims hereinafter appended.

We claim:

1. A computer-implemented method, comprising:
receiving a collection of frames that comprise keyframes;
associating navigation commands with the keyframes;
displaying menu items in keyframes to a user; and
displaying a sequence of frames in response to a command from a user received in response to a selection of at least one of the menu items in a displayed keyframe.

2. The method of claim 1 further comprising exposing an application programmer interface whereby a service provider provides functionality that are associated with the menu items displayed to the user.

3. The method of claim 1 wherein the keyframes are disposed at predetermined locations.

4. The method of claim 1 wherein the keyframes are tagged to indicate keyframe location.

5. The method of claim 1 further comprising displaying a menu item for controlling the speed at which the sequence of frames is displayed.

6. The method of claim 1 wherein the navigation commands comprise transport controls comprising forward and loop commands.

7. The method of claim 1 further comprising replacing frames in the frame collection.

8. The method of claim 1 wherein the navigation commands comprise menu controls comprising up and down commands.

9. The method of claim 1 further comprising applying special effects in response to the received user command.

10. The method of claim 9 wherein the special effects are synchronized to the displayed sequence of frames.

11. The method of claim 1 wherein the displayed menu items are displayed in a camcorder.

12. A point-of-sale kiosk, comprising:
a collection of frames that comprise keyframes;
a navigation structure for controlling navigation between keyframes in the collection of frames; and
a user interface for receiving user commands for causing a sequence of frames to be displayed in response to the navigation structure at the time a command is received from a user.

13. The system of claim 12 wherein the user interface contains a text layer that is overlaid on a video layer.

14. The system of claim 12 wherein the user interface comprises controls for authoring the navigation structure.

15. The system of claim 12 wherein the kiosk further comprises a render engine for applying special effects in response to a received user command.

16. The system of claim 12 wherein the navigation structure contains commands for navigating upwards and downwards in a menu.

17. The system of claim 12 wherein the wherein the navigation structure contains commands for applying special effects.

18. A tangible medium comprising computer-executable instructions for:
receiving a collection of frames that comprise keyframes;
associating navigation commands with the keyframes;
displaying menu items in keyframes to a user; and
displaying a sequence of frames at the time a command is received from a user wherein the command is a selection of at least one of the menu items in a displayed keyframe.

19. The tangible medium of claim 18 wherein the keyframes are tagged to indicate keyframe location.

20. The tangible medium of claim 18 wherein the keyframes are displayed in response to the time-of-day.
